(19) United States
(12) Patent Application Publication
(10) Pub. No.: US 2011/0022850 A1
(43) Pub. Date: Jan. 27, 2011

(54) ACCESS CONTROL FOR SECURE PORTABLE STORAGE DEVICE

(76) Inventors: Hondar LEE, Jhonghe City (TW); Tim Hsieh, Guanyin Towship (TW); Patty Kuo, Neihu District (TW)

Correspondence Address: BIRCH STEWART KOLASCH & BIRCH, PO BOX 747, FALLS CHURCH, VA, 22040-0747, US

(21) Appl. No.: 12/894,892

(22) Filed: Sep. 30, 2010

Related U.S. Application Data
(63) Continuation-in-part of application No. 11/637,110, filed on Dec. 12, 2006.

(30) Foreign Application Priority Data
Jul. 26, 2006 (TW) 095127225
Jul. 26, 2006 (TW) 095127279

(51) Int. Cl. G06F 12/14

(52) U.S. Cl. 713/189

(57) ABSTRACT

A secure portable storage device includes a control module. When a host sends a first key to the control module with a write command so as to command the control module to write the first key into a redirecting file, the control module stores the first key in a temporary working buffer and verifies whether the first key is valid; when the first key is valid, the control module sends a second key and an encrypted content data to the host for generating a third key by decrypting the second key according to the first key and decrypting the encrypted content data into a content data according to the third key. Moreover, when the host sends multiple read commands to the control module in sequence, the control module verifies whether a sequence of the read commands received is valid and sends the second key and the encrypted content data to the host for an encryption. Related apparatuses, methods and techniques also are provided.

This application is a CIP (continuation-in-part application) of U.S. patent application Ser. No. 11/637,110 (the '110 Application), filed on Dec. 12, 2006, which in turn claims party to Taiwanese patent application number 095127279, filed on Jul. 26, 2006. The '110 Application is incorporated herein by reference as though set forth herein in full.

### BACKGROUND OF THE INVENTION

1. Field of the Invention

The present invention relates, among other things, to data storage devices, such as a portable storage device, and more particularly, a secure portable storage device, as well as to apparatuses, methods and techniques involving a data storage device.

2. Description of the Prior Art

Recently portable electronic devices have been increasingly popular. They have evolved from initially being applied as a portable notebook and a record keeper to having an expanded set of versatile functions in the present days.

The storage capacities of common portable electronic devices have limited space; thus, their memory sometimes is expanded or increased by plugging in small flash memory cards, such as memory cards to meet users' needs for storing and/or retrieving bulk data.

As small flash memory cards with different specifications are sequentially launched in the market, users commonly utilize such small flash memory cards to store bulk data. However, because there sometimes are confidential data or copyrighted data among the stored data, users or the data providers often wish to limit the access rights to the stored data to a single user or a specific group of users.

Current secure portable storage devices for this purpose, or the so-called “secure media”, typically solve the problem by storing the content data in an encrypted form in a file system and then sending a verification request to a user's device (sometimes referred to herein as the “host”) when the user tries to access such content. The secure portable storage device and the host are required to cross-verify a key to obtain a valid content key. Next, the encrypted data is decrypted by use of the content key. Finally, the content data is transmitted out to the host. However, this approach means that decryptions must be performed on the secure portable storage device, which the present inventor has discovered results in the fact that the encrypted content data can be easily hacked.

### SUMMARY OF THE INVENTION

Various apparatuses for storing and/or controlling access to data, such as various secure portable storage devices, together with systems, methods and techniques for using such apparatuses, are provided.

According to one representative embodiment, modify, supplement and/or replace the following text based on the ultimate claims that are included A secure portable storage device of the present invention is communicatively connected to a host. The host includes a first decrypting module, a second decrypting module, and a first key storage area in which a first key is pre-stored. The secure portable storage device of the present invention further includes a control module, a restricted storage area, and a file system usage area. The control module is communicatively connected to the host. The restricted storage area is communicatively connected to the control module, and includes a temporary working buffer and a second key storage area. The second key storage area stores a verification key and a second key. The second key is generated by pre-encrypting a third key according to the first key. The file system usage area is communicatively connected to the control module and stores an encrypted content data and a redirecting file. The encrypted content data is generated by pre-encrypting a content data according to the third key. The redirecting file includes a redirecting note toward the restricted storage area. When the host sends the first key to the control module with a write command so as to command the control module to write the first key into the redirecting file, the control module stores the first key in the temporary working buffer according to the redirecting note and compares the first key with the verification key for verifying whether the first key is valid. When the first key is valid, the control module sends the second key and the encrypted content data to the host for the first decrypting module to generate the third key by decrypting the second key according to the first key and for the second decrypting module to decrypting the encrypted content data into the content data according to the third key.

According to an embodiment of the present invention, when the first key is valid, the control module sends the encrypted content data to the host according to an encrypted content data reading command sent by the host.

A secure portable storage device of the present invention is further communicatively connected to a host. The host includes a first decrypting module, a second decrypting module, and a first key storage area in which a first key is pre-stored. The secure portable storage device of the present invention further includes a control module, a restricted storage area, and a file system usage area. The control module is communicatively connected to the host and stores a command sequence. The restricted storage area is communicatively connected to the control module and includes a second key storage area storing a second key. The second key is generated by pre-encrypting a third key according to the first key. The file system usage area is communicatively connected to the control module and stores an encrypted content data. The encrypted content data is generated by pre-encrypting a content data according to the third key. When the host sends a plurality of read commands to the control module in sequence, the control module verifies whether a sequence of the read commands received is valid according to the command sequence. When the sequence of the read commands is valid, the control module sends the second key and the encrypted content data to the host for the first decrypting module to generate the third key by decrypting the second key according to the first key and for the second decrypting module to decrypting the encrypted content data into the content data according to the third key.

Compared with a secure portable storage device in prior art, the secure portable storage device according to the present invention is provided for the host to perform verification of exchanging keys and for sending the second key and the encrypted content data to the host after a valid verification so that the host decrypts the second key and the encrypted content data. As a result, decryptions on the secure portable storage device are avoided such that the encrypted content data is further secured.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a schematic view, according to a first representative embodiment of the present invention, of a secure portable storage device connected to a host;

FIG. 2 is a flow chart showing one example of how a host obtains and decrypts encrypted content data from a secure portable storage device according to the present invention;

FIG. 3 is a schematic view, according to a second representative embodiment of the present invention, of a secure portable storage device connected to a host; and

FIG. 4 is a flow chart showing another example of how a host obtains and decrypts encrypted content data from a secure portable storage device according to the present invention.

### DETAILED DESCRIPTION OF THE PREFERRED EMBODIMENTS

In the following description, numerous details are set forth in order to provide a thorough understanding of the present invention. It will be appreciated by one skilled in the art that the explicitly described details are merely exemplary and that variations on these specific details and/or omissions of them are possible while still remaining within the scope of the present invention. In certain instances, well-known components are not described in detail in order not to unnecessarily obscure the present invention.

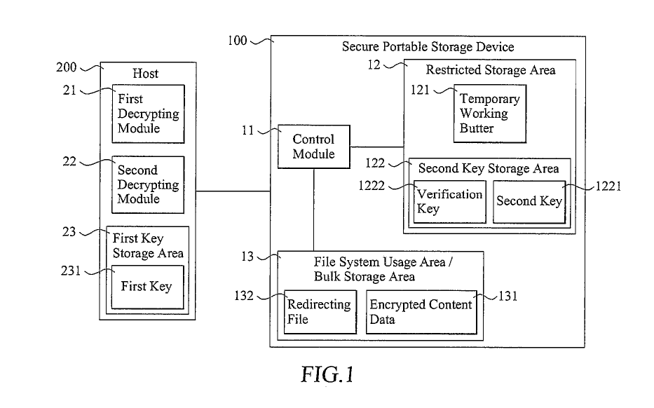

FIG. 1 is a schematic view illustrating a first embodiment of a secure portable storage device 100, according to a representative embodiment of the present invention, communicatively connected to a host 200. The host 200 can be, e.g., a general-purpose computer or processing device, a cellular-based wireless telephone, any other kind of handheld communication device, an MP3 player, a digital video and/or audio disc playing device, a portable gaming device, any other kind of media playing device, or a personal digital assistant. In the current embodiment, host 200 includes a first decrypting module 21, a second decrypting module 22, and a first key storage area 23, in which a first key 231 is pre-stored. First decrypting module 21 and second decrypting module 22 may be implemented in software and/or firmware (i.e., performed by a general-purpose or special-purpose processor performing previously stored or encoded computer-executable process steps), special-purpose hardware (e.g., an appropriately configured arrangement of logic gates), or any combination of the foregoing, and in alternate embodiments first decrypting module 21 and second decrypting module 22 may be combined into a single module.

The secure portable storage device 100 of the present embodiment can be any portable storage device, such as any device conforming to the specifications for a CompactFlash Card, a SmartMedia Card, a MultiMedia Card, a Memory Stick Card, an SD Memory Card, an XD-Picture Card, or any other (preferably smart) card that might be devised in the future. In the current embodiment, portable storage device 100 includes a control module 11, e.g., implemented as a general-purpose or special-purpose processor that performs computer-executable process steps (preferably stored as firmware in order to provide enhanced security) and/or implemented using special-purpose hardware (for even greater security), and at least one computer-readable storage medium that includes a restricted storage area 12 and a bulk storage area, implemented here as a file system usage area 13, but in any event preferably at least including an area formatted as a file system (e.g., according to the FAT 12 file system specification, the FAT 16 file system specification, the FAT 32 file system specification, or the NTFS file system specification).

In the preferred embodiments, the bulk storage area 13 is generally accessible (e.g., to a separate processor such as host 200), while the restricted storage area 12 is only accessible to control module 11 for its internal processing purposes. In certain embodiments, restricted storage area 12 is in a completely separate storage medium, such as integrated into the same chip as control module 11. In other embodiments, restricted storage area 12 is part of the same storage medium as bulk storage area 13, but, e.g., due to the configuration of control module 11 and/or stored access-control processing steps (e.g., as part of the firmware for control module 11), is only accessible to control module 11.

The control module 11 is communicatively connected to the host 200 (i.e., entirely via direct physical connections in the present embodiment, but potentially including network and/or wireless connections in alternate embodiments). The restricted storage area 12 is communicatively connected to the control module 11, and in the present embodiment includes a temporary working buffer 121 and a second key storage area 122. The second key storage area stores a second key 1221 and a verification key 1222. The second key 1221 previously has been generated, in the present embodiment, by pre-encrypting a third key (not shown) using the first key 231 (or another key for which the first key 231 is the associated decryption key). The temporary working buffer 121 and the second key storage area 122 in the restricted storage area 12 (together with the rest of restricted storage area 12) preferably do not correspond to any externally accessible logical block address (LBA), but instead are only controllable and accessible by the control module 11. Therefore, even if hackers try to read the data stored in the restricted storage area 12 by means of a copy operation, they are not able to do so. Moreover, if storage device 100 is implemented as a flash memory card, the arrangements of memory blocks vary from card to card, due to the numbers and different arrangements of bad blocks inside different flash memory cards. Therefore, even if hackers copy the secure portable storage device 100 of the present invention to another flash memory card, they cannot copy the data stored in the restricted storage area 12.

The file system usage area 13 is communicatively connected to the control module 11 and stores encrypted content data 131 and a “redirecting file” 132. The encrypted content data 131 previously has been generated, in the present embodiment, by pre-encrypting content data (not shown) using the third key (or another key for which the third key is the associated decryption key). In the present embodiment, the redirecting file 132 includes a “redirecting note” (not shown) toward the restricted storage area 12 and, more specifically, toward the temporary working buffer 121 in the restricted storage area 12. This “redirecting note” signals the control module 11 to immediately transfer any value written into the redirecting file 132 to the temporary working buffer 121 in the restricted storage area 12. However, in alternate embodiments such a separate “redirecting note” can be omitted, e.g., with the control module 11 simply monitoring for any commands to write to the redirecting file 132 (or other designated location) and then automatically redirecting any value written there. That is, the redirecting instruction can be stored in the redirecting file 132 itself and/or in computer-executable instructions being performed by the control module 11.

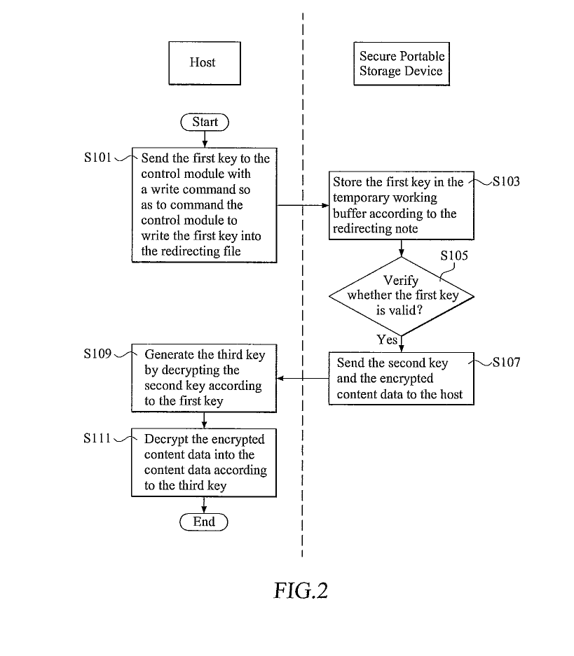

FIG. 2 is a flow chart showing an exemplary process by which a host 200 obtains and decrypts the encrypted content data 131 from the secure portable storage device 100. When the host 200 sends a value (here, the first key 231) to the control module 11 with a write command, so as to command the control module 11 to write the value into the redirecting file 132 (step S101), the control module 11 stores the value in the temporary working buffer 121 in the restricted storage area 12, according to the redirecting note and/or other redirecting instruction (step S103). Preferably, upon redirecting the transmitted value to the restricted storage area 12, control module 11 immediately deletes or overwrites the value (if any) that has been stored in the redirecting file 132, so as to limit access to it by unauthorized entities. In this regard, it is noted that in certain embodiments, the process steps according to the present invention may be able to intercept the command to store a value into the redirecting file 132 and instead initially store the value into the restricted storage area 12. However, in other embodiments, such as where the inventive process steps are supplemental to process steps being executed according to an established memory-card standard, the value initially is in fact stored into redirecting file 132, but then immediately copied and deleted from there and stored into the restricted storage area 12 (by control module 11).

In any event, in the present embodiment, upon completion of such redirection, the control module 11 compares the value in the temporary working buffer 121 in the restricted storage area 12 (here, first key 231) with the verification key 1222 for verifying whether the first key 231 is valid (step S105). In alternate embodiments, the verification key 1222 may be used in any other manner in order to determine if the value stored in the temporary working buffer 121 is valid (e.g., comparing a hash or any other function of the stored value to the verification key 1222). Still further, the verification key 1222 may comprise (or be a part of) a table of values, any one of which being capable of validating the value stored in the temporary working buffer 121.

In any event, only if the first key 231 is determined to be valid, the control module 11 makes a decryption key (here, the second key 1221) available to the host 200 (step S107). In the present embodiment, the control module 11 simply automatically sends the second key 1221, together with the encrypted content data 131, to the host 200 in step S107. However, in alternate embodiments the control module 11, e.g., copies the second key 1221 into a portion of the bulk storage area 13 (e.g., deleting or overwriting it after a short period of time) so that it can be read by host 200 or otherwise makes the second key 1221 available for reading by host 200 (e.g., during a limited period of time). In any event, control module 11 preferably allows only a single transfer (or reading) of the second key 1221 in response to each command to write a value (ultimately determined to be valid) from host 200 to the redirecting file 132 (i.e., once for each security authentication).

In the present embodiment, redirecting file 132 is used to provide additional security. However, in alternate embodiments (e.g., using different security measures) a command to write a value (ultimately determined to be valid) from host 200 to a different designated location (i.e., one that does not result in redirection) causes control module 11 to make the second key 1221 (or a different decryption key) available to the host 200.

In any event, in the present embodiment upon receiving the second key 1221, the first decrypting module 21 of the host 200 generates the third key by decrypting the second key 1221 using the first key 231 (step S109) as a decryption key, and then the second decrypting module 22 decrypts the encrypted content data 131 to provide the content data (not shown) using the third key as a decryption key (step S111). Thereafter, the content data can be played, displayed or otherwise used by the host 200.

According to a preferred embodiment of the present invention, when (or only after) the first key 231 has been determined to be valid, the control module 11 waits for the host to send an encrypted-content-data-reading command (not shown), and then in response sends the encrypted content data 131 to the host 200. For this purpose, in certain embodiments control module 11 may limit the amount of time during which an encrypted-content-data-reading command will be processed after the security authentication has been completed.

When compared with a secure portable storage device in the prior art, the secure portable storage device 100 according to the present embodiment of the invention performs verification of exchanged keys before sending the second key 1221 and the encrypted content data 131 to the host 200, after which the host 200 decrypts the second key 1221 and then the encrypted content data 131. As a result of this approach, decryptions on the secure portable storage device 100 are avoided; moreover, because neither the first key 231 nor the second key 1221 is stored in the file system usage area 13 (or in any other generally or readily accessible storage area) of the secure portable storage device 100 in the present embodiment, hackers cannot obtain any information useful for decrypting the encrypted content data from the file system usage area 13 (or any other readily accessible storage area). That is, the secure portable storage device 100 of the present embodiment has the ability to significantly improve the security of the encrypted content data 131.

It is noted that in the foregoing embodiment, the value that is sent by the host 200 for verification purposes is the same value (i.e., the first key 231) that is used to decrypt the second key 1221 that subsequently is provided by the secure portable storage device 100. However, in alternate embodiments these two functions are separated, so that one value is transmitted by host 200 for verification purposes and a different value (e.g., the first key 231) is used to decrypt the second key 1221.

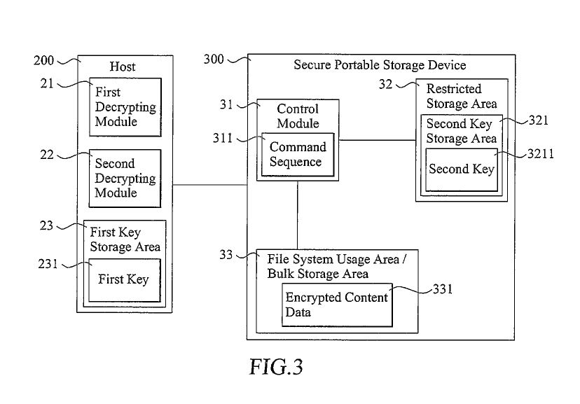

Due to the fact that some storage devices in the market are read-only and do not support write commands, a secure read-only portable storage device is further provided according to the present invention. FIG. 3 is a schematic view showing a second embodiment of a secure portable storage device 300 according to the present invention, communicatively connected to host 200. As in the previous embodiment, the host 200 includes a first decrypting module 21, a second decrypting module 22, and a first key storage area 23 in which a first key 231 is pre-stored. The secure portable storage device 300 includes a control module 31, a restricted storage area 32, and a file system usage area/bulk storage area 33. Except as otherwise noted below, the same considerations pertaining to control module 11, restricted storage area 12 and file system usage area/bulk storage area 13 also apply to control module 31, restricted storage area 32, and file system usage area/bulk storage area 33, respectively. In fact, as a general matter, the considerations pertaining to the embodiment described above also pertain to the present embodiment except as otherwise noted below.

The control module 31 is communicatively connected to the host 200 and stores a specified command sequence 311. As discussed in greater detail below, in the present embodiment control module 31 is configured to perform certain actions when a command sequence corresponding to sequence 311 is received from a connected host 200. The restricted storage area 32 is communicatively connected to the control module 31 and includes a second key storage area 321 storing a second key 3211. The second key 3211 previously has been generated by pre-encrypting a third key (not shown) using the first key 231 (or another key for which the first key 231 is the associated decryption key).

The file system usage area/bulk storage area 33 is communicatively connected to the control module 31 and stores encrypted content data 331. The encrypted content data 331 previously has been generated by pre-encrypting content data (not shown) according to the third key (or another key for which the third key is the associated decryption key).

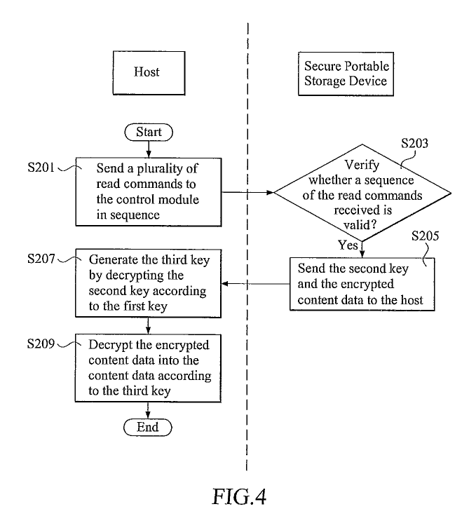

FIG. 4 is a flow chart showing an exemplary process by which the host 200 obtains and decrypts the encrypted content data 331 from the secure portable storage device 300. When the host 200 sends a plurality of read commands to the control module 31 (or, more generally, to the secure portable storage device 300) in sequence (step S201), the control module 31 verifies whether the sequence of read commands received is valid according to the pre-stored command sequence 311 (step S203), e.g., whether the received command sequence identically matches the pre-stored command sequence 311. For this purpose, the control module 31 might continuously monitor received commands on a rolling basis, looking for any received sequence that matches the pre-stored command sequence 311. Alternatively, the control module 31 might only compare the pre-stored command sequence 311 to sequences of commands that are received as a group over a relatively short maximum-duration pre-specified interval of time. In any event, a match preferably requires a sequence of read commands reading from specified addresses (or other specific locations) in a pre-designated order, e.g., with a minimum of 5 or 10 required read commands (i.e., the pre-stored command sequence 311 preferably is at least 5 or 10 commands long).

When the sequence of the read commands is determined to be valid, the control module 31 makes a decryption key (here, the second key 3211) available to the host 200 (step S205). In the present embodiment, the control module 11 simply automatically sends the second key 3211, together with the encrypted content data 331 to the host 200 in step S205. However, in alternate embodiments the control module 11, e.g., copies the second key 3211 into a portion of the bulk storage area 13 (e.g., deleting or overwriting it after a short period of time) so that it can be read by host 200 or otherwise makes it available for reading by host 200 (e.g., during a limited period of time). In any event, control module 11 preferably allows only a single transfer (or reading) of the second key 3211 in response to each verified command sequence from host 200 (i.e., once for each security authentication).

In any event, in the present embodiment upon receiving the second key 3211, the first decrypting module 21 of the host 200 generates the third key by decrypting the second key 3211, using the first key 231 as a decryption key (step S207), and then the second decrypting module 22 decrypts the encrypted content data 331 to provide the content data, using the third key as a decryption key (step S209). Thereafter, the content data can be played, displayed or otherwise used by the host 200.

This second embodiment of the secure portable storage device 300 according to the present invention also permits decryptions on the secure portable storage device 300 to be avoided. Moreover, because neither the first key 231 nor the second key 3221 is stored in the file system usage area 33 (or in any other generally or readily accessible storage area) of the secure portable storage device 300 in the present embodiment, the encrypted content data 331 is further secured.

In conclusion, the secure portable storage devices 100 and 300 of the present invention have the ability to improve the security of stored encrypted content data for either a read/write storage device or a read-only storage device.

In the foregoing embodiments, the decryption key (i.e., second key 1221 or 3211) sent by the secure portable storage device (100 or 300) is an encrypted key which, once decrypted, can be used to decrypt the encrypted content data (131 or 331). However, in alternate embodiments the decryption key provided by the secure portable storage device (100 or 300) instead is used in any of a variety of other ways for the purpose of ultimately decrypting the encrypted content (e.g., providing an unencrypted content decryption key or a key that is combined in any other manner with a key stored by the host in order to produce the required content decryption key).

It is noted that any of a variety of different key-based encryption and decryption techniques may be used in connection with the present invention. Such techniques may include, e.g., standard existing techniques, newly developed techniques and/or proprietary techniques.

The foregoing description generally concerns a secure portable storage device. However, it should be noted that any or all of the structures and/or functionality described above as being associated with a secure portable storage device (100 or 300) instead could be incorporated into a larger device, e.g., integrated as one unit with the host. In this regard, for example, the control module (e.g., 11 or 31) and the associated computer-readable storage medium (e.g., including restricted storage area 12 or 32 and bulk storage area 13 or 33) can be part of an embedded memory or storage system within a larger electronic device (e.g., any of the types of devices mentioned above as examples of host 200).

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

While the present invention has been particularly shown and described with reference to certain preferred embodiments, it will be understood by those skilled in the art that various changes in form and detail may be without departing from the spirit and scope of the present invention. Accordingly, the invention is not limited to the precise embodiments shown in the drawings and described above. Rather, it is intended that all such variations not departing from the spirit of the invention be considered as within the scope thereof as limited solely by the claims appended hereto.

What is claimed is:

1. An apparatus comprising:
(a) a computer-readable storage medium that includes a bulk storage area and a restricted storage area, with the bulk storage area storing encrypted content, and with the restricted storage area storing a decryption key for use in decrypting the encrypted content and a verification key; and
(b) a control module operatively coupled to said computer-readable storage medium and configured to perform the following steps upon receiving a command to store a value into a specified first location in the bulk storage area:
(i) automatically redirecting the value into a second location in the restricted storage area,
(ii) determining if the value is valid by using the verification key, and then
(iii) only if the value is valid, allowing the decryption key to be transferred.

2. An apparatus according to claim 1, wherein the decryption key must itself be decrypted before being used to decrypt the encrypted content.

3. An apparatus according to claim 2, wherein the value that has been verified can be used to decrypt the decryption key.

4. An apparatus according to claim 1, wherein the encrypted content is stored within a file system in the bulk storage area.

5. An apparatus according to claim 1, wherein the control module and the computer-readable storage medium are incorporated within a portable storage device.

6. An apparatus according to claim 1, wherein said steps are stored as firmware.

7. An apparatus according to claim 1, wherein said determining step comprises comparing the value to the verification key.

8. An apparatus according to claim 1, wherein when the value is determined to be valid, the control module automatically sends the encrypted content and the decryption key to a device that issued the command to store the value into the specified first location.

9. An apparatus according to claim 1, wherein the control module sends the encrypted content in response to a command to read the encrypted content, but only after the value is determined to be valid.

10. An apparatus according to claim 1, wherein the restricted storage area is only accessible to the control module for its internal processing purposes.

11. An apparatus comprising:
(a) a computer-readable storage medium that includes a bulk storage area and a restricted storage area, with the bulk storage area storing encrypted content, and with the restricted storage area storing a decryption key for use in decrypting the encrypted content and verification information; and
(b) a control module operatively coupled to said computer-readable storage medium and configured to perform the following steps upon receiving data-read commands to read data from the bulk storage area:
(i) checking sequences of the data-read commands against the verification information in an attempt to identify a matching read command sequence, and then
(ii) only if the matching read command sequence has been identified, allowing the decryption key to be transferred.

12. An apparatus according to claim 11, wherein the decryption key must itself be decrypted before being used to decrypt the encrypted content.

13. An apparatus according to claim 11, wherein the encrypted content is stored within a file system in the bulk storage area.

14. An apparatus according to claim 11, wherein the control module and the computer-readable storage medium are incorporated within a portable storage device.

15. An apparatus according to claim 11, wherein the restricted storage area is only accessible to the control module for its internal processing purposes.

16. An apparatus according to claim 11, wherein the matching read command sequence comprises a sequence of commands to read from specific locations in a specified order.

17. An apparatus according to claim 11, wherein when the matching read command sequence has been identified, the control module automatically sends the encrypted content and the decryption key to a device that issued the matching read command sequence.

18. An apparatus according to claim 11, wherein the control module sends the encrypted content in response to a command to read the encrypted content, but only after the matching read command sequence has been identified.
